(19) United States
(12) Patent Application Publication
(10) Pub. No.: US 2008/0122217 A1
(43) Pub. Date: May 29, 2008

(54) Security Document and Method for the Production Thereof

(76) Inventors: Sandrine Rancien, La Murette (FR); Nathalie Vast, Mont Saint Eloi (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/558,015

(22) PCT Filed: May 19, 2004
(86) PCT No.: PCT/FR04/01227

§ 371 Date: Sep. 26, 2007

(30) Foreign Application Priority Data
May 26, 2003 (FR) 03/06352

(51) Int. Cl. B42D 15/00

(52) U.S. Cl. 283/72

(57) ABSTRACT

The present invention relates to a security document, useful in particular for preventing falsification and counterfeiting of payment vouchers or official documents by reproduction, characterized in that it includes, as security means, a security protection feature (M) consisting of a first feature (M1) formed from substances exhibiting an interferential effect and of a second feature (M2) formed from substances that react to certain stimulations, such as light radiation or thermal, magnetic, electromagnetic, electrical or microwave-type stimulation, giving a light response visible to the human eye or a specific signal detectable by means of a suitable apparatus.

The invention also relates to the method of producing said document.

The present invention relates to a security document with a plastic or paper substrate having as security means, to protect against falsification and counterfeiting of payment vouchers or official documents, at least one security protection feature.

It is known that, to protect against any falsification and counterfeiting of payment vouchers or official documents, such as bank notes, checks, savings passbooks, short-term notes, account-books, securities, notarial deeds, credit cards, identity cards and passports, several technical solutions have been envisioned in the past, these being based on the use of security means such as watermarks, on the one hand, and colored, metalized or magnetizable threads, fibers and strips, the state of the art being illustrated by the description of British patent No. 1 127 043.

According to the invention, a novel technical solution is recommended for solving the problem of preventing falsification and counterfeiting of payment vouchers and official documents, which relies on the use of a novel security means. This technical solution also allows better authentication.

One of the objects of the invention is to propose a novel security means that prevents the reproduction, for example by color photocopying, of said security document.

Another object of the invention is also to propose a novel security means that allows a number of indicia or symbols to be added to said security document, these being legible, completely or partly, under particular viewing conditions or by using a suitable apparatus, in particular those which are not directly visible by the user under normal viewing conditions.

The Applicant's idea is therefore to affix to said security document a single security protection feature which combines both the property of preventing photocopying and of being completely or partly legible only under particular viewing conditions or by means of a suitable apparatus.

A first solution envisioned by the Applicant was in fact to use a feature formed partly from substances possessing an interferential effect.

This is because certain substances possess the property of producing a variable color effect that depends on the viewing angle.

Since this optical effect is impossible to reproduce by current techniques, it is therefore easy to detect, when they are photocopied, counterfeit security documents because said interferential effects, and therefore said substances, are absent.

Among substances exhibiting an interferential effect, it is known to use iridescent substances.

Among iridescent substances that can be used according to the invention, mention may especially be made of extracts of mother-of-pearl, lead salts and micas. In this regard the preferred substances are micas since extracts of mother-of-pearl are very expensive and lead salts, because of their toxicity, have to comply with very strict health and safety rules.

Among recommended suitable iridescent substances are micas coated with at least one metal oxide, and in particular the products sold by Merck AG under the name IRIODINE, these products being micas coated with TiO₂ with, where appropriate, at least one other metal oxide.

Other substances exhibiting optical interference phenomena that may constitute anticopying systems for bank notes or other security documents have been disclosed in patent application WO 01/60924.

These form part of solutions that the Applicant initially envisioned using.

In particular, these are optically variable particles (called OVPs by those skilled in the art) that take the form of a thin film obtained by laminating one or more dielectric layers between one or more reflecting metal layers.

The colors assumed by these structures depend in fact on the constituent material of each layer, on the sequence and number of layers, on the thickness of each layer and on the process for producing the film itself.

These are also liquid crystal pigments or liquid crystals.

Finally, these are polymeric multilayer films formed by an alternation of layers of greater or lesser reflectivity.

However, the Applicant has found that the use of this single security means may, with the increasing perfectionism of today's criminals, prove to be insufficient for combating all attempts at counterfeiting said security documents.

The Applicant has therefore had the idea of using, within one and the same security protection feature, both a means that can prevent it being reproduced by a reprographic method and a means that can make certain indicia or symbols in this feature undetectable unless under suitable read conditions.

In this regard, it seemed to the Applicant to be useful to combine, within one and the same security protection feature, substances exhibiting an interferential effect, as mentioned above, with substances that react to certain stimulations, such as light radiation or thermal, magnetic, electromagnetic or electrical stimulation, giving a light response visible to the human eye or detectable by a suitable apparatus.

Within such substances, there are in particular phosphorescent, fluorescent, infrared-sensitive, ultraviolet-sensitive, thermochromic and photochromic substances, and also all substances that can be excited by microwave, magnetic or electrical fields.

Among substances that react to UV, mention may be made of pigments that re-emit in the visible when they are excited at wavelengths of 365 nm or 254 nm, such as the mineral or organic pigments supplied by Nemoto and Honeywell. Mention may also be made, as examples of pigments that re-emit with a different color at the two abovementioned wavelengths, of the pigment CD R/GI from Honeywell.

Mention may also be made of pigments called “up-converter”, or anti-Stokes pigments that are excited in the IR and re-emit in the visible, such as the pigment LUMILUX UC6 from Honeywell.

Likewise, pigments may be used that are excited in the UV and re-emit in the IR, such as the pigment IR CD 139 from Honeywell, which is excited at a wavelength close to 300 nm and re-emits between 900 and 1000 nm. Note, there are also pigments that are excited in the IR and re-emit in the IR, such as the pigment IR CD 170 from Honeywell, which is excited at a wavelength of 620 nm and re-emits at around 1050 nm.

As regards thermochromic substances, the Matsui products with the reference CHROMICOLOR Aqualite AQ ink may be mentioned. These products are colored at room temperature but become colorless at a higher temperature. In this case, rather a dark color will be chosen for the thermochromic capsules exposed to ambient temperature which, combined with substances exhibiting an interferential effect, give an enhanced interferential appearance under normal viewing conditions.

This is because the underlying dark color enhances the variable color effect according to the angle of inclination of the support produced by the interferential substances.

This is particularly visible when interferential substances of the liquid-crystal type are used.

However, when heated these thermochromic substances become bleached, thus making the interferential substances have a visually different appearance, this effect generally being reversible.

It is also possible to use substances that undergo a reverse reaction in terms of a color change, going from colorless to a color under the action of heat.

As examples of photochromic substances, mention may be made of the Matsui products with the reference Photopia AQ ink, which exhibit a reversible reaction, going from colorless to colored when exposed to white light or UV.

It would also be possible to combine interferential substances with substances that react to certain stimulations, such as magnetic, electrical, electromagnetic or microwave-type stimulations, emitting a specific signal detectable by means of a suitable apparatus.

In particular, these substances may be metallic substances that react to a microwave excitation, such as 316L stainless steel, substances exhibiting soft or hard magnetism having a characteristic response in a given magnetic field, such as for example the hard magnetic substances supplied by Pyral, or else substances having a certain conductivity in an electric field, such as the film-forming aluminum powder of very fine particle size, of less than 50 μm, supplied by Radium Bronze. The latter particles, owing to their high reflectivity, could also modify the variable color effect produced by the interferential substances under normal viewing conditions.

To form said security protection feature, several of the aforementioned substances may also be combined together.

This multiple protection associated with such a security protection feature has real advantages.

Firstly, it results in a security protection feature that combines the respective properties of each of the substances involved.

This is because the properties of a substance exhibiting an interferential effect suffer little or no reduction or do not disappear when this substance is combined with the other substances mentioned above.

Secondly, it may confuse a would-be counterfeiter, for which the presence of a protection readily visible at one particular place on a security paper would not encourage him to look for another possible protection at the same place or in an area contiguous therewith, which other protection would be invisible under normal viewing conditions.

It may also be conceivable for the overall security protection feature to be a combination of a feature formed from substances exhibiting an interferential effect with a feature formed from substances possessing variable optical effects depending on the viewing conditions, other than an interferential effect or one that reacts specifically to certain stimulations.

The respective features of each of the substances may consequently be completely or partly superimposed or, on the contrary, they may be contiguous.

One simple technical solution for achieving this result is to apply a layer formed from a proportioned mixture of the two substances on a paper or plastic substrate—the two features will, in this way, be completely identical and will represent one and the same final security protection feature.

This layer may advantageously be applied by printing, especially by gravure printing or by screen printing, and will consist of a proportioned mixture of the substances that react to certain stimulations, such as light radiation or thermal, magnetic, electromagnetic or electrical stimulation, giving a light response visible to the human eye or detectable by a suitable apparatus.

Another technical solution will also be to apply, to the security document, in succession a layer comprising substances exhibiting an interferential effect, thus forming a first security protection feature, and a layer having substances that react to certain stimulations, such as light radiation or thermal, magnetic, electromagnetic or electrical stimulation, giving a light response visible to the human eye or detectable by a suitable apparatus.

These two features may consequently be either identical, thus again providing the result obtained by applying a single layer, or partially superimposed, or contiguous, or else completely separate, resulting in a compound final feature.

From this standpoint, it may be advantageous to provide a final feature of the alphanumeric type, in which parts of the symbols or letters would be formed by the first feature and the other parts of these same symbols or letters would be formed by the second feature.

In normal viewing, that is to say in white light, the final feature would be illegible, half of each letter or symbol for example being cut off. However, under the action of an external stimulation, such as for example a temperature rise, the final feature would appear in its entirety.

It is also conceivable to provide a final alphanumeric-type feature in which certain symbols or letters would be formed by the first feature and certain other symbols or letters would be formed by the second feature.

In normal viewing, that is to say in white light, the final feature would this way exhibit a uniform interferential effect according to the first feature, the second feature therefore being invisible. However, under the action of an external stimulation, such as light emitting ultraviolet radiation for example, the second alphanumeric-type feature would be revealed during the stimulation.

Similarly, it is also conceivable to form a final feature of the barcode type, in which certain bars would be formed by the first feature and certain other bars would be formed by the second feature.

This embodiment will not only guarantee more reliable authentication of the security document having said security protection feature, but will also guarantee a certain traceability in the process for obtaining said document. For example, if the document has not undergone an intermediate operation intended to reveal the second feature, especially by exposure to certain stimulations of the light, thermochromic or photochromic type, will necessarily have a final feature in the form of a truncated barcode, and therefore one that cannot be read by means of a suitable read device.

In another conceivable embodiment of the invention, the final feature would combine a first feature formed from alphanumeric data with a second feature constituting a barcode.

It is an object of the present invention therefore to propose a security document, useful in particular for preventing falsification and counterfeiting of payment vouchers or official documents by reproduction, characterized in that it includes, as security means, a security protection feature (M) consisting of a first feature (M1) formed from substances exhibiting an interferential effect and of a second feature (M2) formed from substances that react to certain stimulations, such as light radiation or thermal, magnetic, electromagnetic, electrical or microwave-type stimulation, giving a light response visible to the human eye or a specific signal detectable by means of a suitable apparatus.

According to one embodiment of the invention, the substances exhibiting an interferential effect are chosen from iridescent particles, especially from the set formed by extracts of mother-of-pearl, lead salts and micas.

In particular, the iridescent particles are micas coated with at least one metal oxide, and preferably a TiO₂-coated mica.

According to another embodiment of the invention, the substances exhibiting an interferential effect are formed from a thin film obtained by laminating one or more dielectric layers between one or more reflecting metal layers.

According to another embodiment of the invention, the substances exhibiting an interferential effect are liquid crystal pigments or liquid crystals.

According to a final embodiment of the invention, the substances exhibiting an interferential effect are formed from a polymeric multilayer film consisting of an alternation of layers of greater or lesser reflectivity.

According to a preferred configuration of the invention, the substances that react to certain stimulations giving a light response visible to the human eye are chosen from the set formed by phosphorescent, fluorescent, infrared-sensitive, ultraviolet-sensitive, thermochromic or photochromic substances.

According to another preferred configuration of the invention, the substances that react to certain stimulations giving a specific signal detectable by means of a suitable apparatus are substances that react to magnetic, electrical, electromagnetic or microwave-type fields.

In particular, the first feature (M1) completely covers the second feature (M2), or vice versa.

Again in particular, the first feature (M1) partly covers the second feature (M2), or vice versa.

Again in particular, the first feature (M1) and the second feature (M2) are contiguous.

Again in particular, the security protection feature (M) is an alphanumeric-type feature.

Again in particular, the security protection feature (M) is a barcode-type feature.

Again in particular, the feature (M1) is an alphanumeric-type feature and the feature (M2) is a barcode-type feature.

According to a preferred configuration of the invention, the feature (M1) has a gloss value of greater than 12, the gloss being measured according to the ISO 2813 standard using a Gardner glossmeter at a measurement angle of 75°.

According to another preferred configuration of the invention, the security document is a bank note.

It is another object of the present invention to propose a method of producing a security document as described above, characterized in that a security protection feature (M) consisting of a first feature (M1) formed from substances exhibiting an interferential effect and of a second feature (M2) formed from substances that react to certain stimulations, such as light radiation or thermal, magnetic, electromagnetic, electrical or microwave-type stimulation, giving a light response visible to the human eye or a specific signal detectable by means of a suitable apparatus, is affixed to the substrate of said document.

According to one embodiment of the invention, the features (M1) and (M2) are applied simultaneously by depositing a single layer comprising a mixture of substances exhibiting an interferential effect and of substances that react to certain stimulations, such as light radiation or thermal, magnetic, electromagnetic, electrical or microwave-type stimulation, giving a light response visible to the human eye or a specific signal detectable by means of a suitable apparatus.

According to another embodiment of the invention the features (M1) and (M2) are applied separately, by successively depositing a layer comprising substances exhibiting an interferential effect and a layer comprising substances that react to certain stimulations, such as light radiation or thermal, magnetic, electromagnetic, electrical or microwave-type stimulation, giving a light response visible to the human eye or a specific signal detectable by means of a suitable apparatus, or vice versa.

According to a preferred embodiment of the invention, the features (M1) and (M2) are applied by screen printing or by gravure printing.

According to a preferred embodiment of the invention, the substrate is a bank note paper.

1. A security document, useful in particular for preventing falsification and counterfeiting of payment vouchers or official documents by reproduction, which includes, as security means, a security protection feature (M) consisting of a first feature (M1) formed from substances exhibiting an interferential effect and of a second feature (M2) formed from substances that react to certain stimulations, such as light radiation or thermal, magnetic, electromagnetic, electrical or microwave type stimulation, giving a light response visible to the human eye or a specific signal detectable by means of a suitable apparatus.

2. The security document as claimed in claim 1, wherein the substances exhibiting an interferential effect are chosen from iridescent particles, especially from the set formed by extracts of mother of pearl, lead salts and micas.

3. The security document as claimed in claim 2, wherein the iridescent particles are micas coated with at least one metal oxide, and preferably a TiO2 coated mica.

4. The security document as claimed in claim 1, wherein the substances exhibiting an interferential effect are formed from a thin film obtained by laminating one or more dielectric layers between one or more reflecting metal layers.

5. The security document as claimed in claim 1, wherein the substances exhibiting an interferential effect are liquid crystal pigments or liquid crystals.

6. The security document as claimed in claim 1, wherein the substances exhibiting an interferential effect are formed from a polymeric multilayer film consisting of an alternation of layers of greater or lesser reflectivity.

7. The security document as claimed in claim 1, wherein the substances that react to certain stimulations giving a light response visible to the human eye are chosen from the set formed by phosphorescent, fluorescent, infrared sensitive, ultraviolet sensitive, thermochromic or photochromic substances.

8. The security document as claimed in claim 1, wherein the substances that react to certain stimulations giving a specific signal detectable by means of a suitable apparatus are substances that react to magnetic, electrical, electromagnetic or microwave type fields.

9. The security document as claimed in claim 1, wherein that the first feature (M1) completely covers the second feature (M2), or vice versa.

10. The security document as claimed in claim 1, wherein the first feature (M1) partly covers the second feature (M2), or vice versa.

11. The security document as claimed in claim 1, wherein the first feature (M1) and the second feature (M2) are contiguous.

12. The security document as claimed in claim 1, wherein the security protection feature (M) is an alphanumeric type feature.

13. The security document as claimed in claim 1, wherein the security protection feature (M) is a barcode type feature.

14. The security document as claimed in claim 1, wherein the feature (M1) is an alphanumeric type feature and the feature (M2) is a barcode type feature, or vice versa.

15. The security document as claimed in one claim 1, wherein the feature (M1) has a gloss value of greater than 12, the gloss being measured according to the ISO 2813 standard using a Gardner glossmeter at a measurement angle of 75°.

16. The security document as claimed in claim 1, wherein the security document is a bank note.

17. A method of producing a security document as claimed in claim 1, wherein a security protection feature (M) consisting of a first feature (M1) formed from substances exhibiting an interferential effect and of a second feature (M2) formed from substances that react to certain stimulations, such as light radiation or thermal, magnetic, electromagnetic, electrical or microwave type stimulation, giving a light response visible to the human eye or a specific signal detectable by means of a suitable apparatus, is affixed to the substrate of said document.

18. The production method as claimed in claim 17, wherein the features (M1) and (M2) are applied simultaneously by depositing a single layer comprising a mixture of substances exhibiting an interferential effect and of substances that react to certain stimulations, such as light radiation or thermal, magnetic, electromagnetic, electrical or microwave type stimulation, giving a light response visible to the human eye or a specific signal detectable by means of a suitable apparatus.

19. The production method as claimed in claim 17, wherein the features (M1) and (M2) are applied separately, by successively depositing a layer comprising substances exhibiting an interferential effect and a layer comprising substances that react to certain stimulations, such as light radiation or thermal, magnetic, electromagnetic, electrical or microwave type stimulation, giving a light response visible to the human eye or a specific signal detectable by means of a suitable apparatus, or vice versa.

20. The production method as claimed in claim 17, wherein the features (M1) and (M2) are applied by screen printing or by gravure printing.

21. The production method as claimed in claim 17, wherein the substrate of said document is a bank note paper.
